(19) United States
(12) Patent Application Publication
(10) Pub. No.: US 2025/0039772 A1
(43) Pub. Date: Jan. 30, 2025

(54) NETWORK INTEROPERABILITY

(71) Applicant: Nokia Technologies Oy, Espoo (FI)

(72) Inventors: Jussi-Pekka KOSKINEN, Oulu (FI); Samuli Heikki TURTINEN, Ii (FI)

(21) Appl. No.: 18/716,234

(22) PCT Filed: Dec. 9, 2021
(86) PCT No.: PCT/EP2021/085085

§ 371 Date: Jun. 4, 2024

(51) Int. Cl. H04W 48/10

(52) U.S. Cl. CPC H04W 48/10

(57) ABSTRACT

An apparatus configured to perform as a user equipment of a first type, receive system information from a cell and determine, based on the system information, that the cell does not support user equipments of the first type, and determine, whether to camp on the cell or to not camp on the cell.

### FIELD

The present disclosure relates to interoperability of communication devices with differing capabilities.

### BACKGROUND

In cellular communications, network nodes and user equipments, UEs, need to conform to the same, or at least compatible, specifications to obtain dependable inter-operation with products in different roles in the cellular network, even when the products are manufactured by different manufacturers.

A network cell may broadcast information on the cell the UE may use in deciding, whether to seek camping, attachment or registration to the cell. When attaching or registering, the UE may inform the cell of its capabilities, as UE devices may have differing sets of capabilities.

### SUMMARY

According to some aspects, there is provided the subject-matter of the independent claims. Some embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided an apparatus comprising at least one processing core, at least one memory including computer program code, the at least one memory and the computer program code being configured to, with the at least one processing core, cause the apparatus at least to perform as a user equipment of a first type, receive system information from a cell and determine, based on the system information, that the cell does not support user equipments of the first type, and determine, whether to camp on the cell or to not camp on the cell.

According to a second aspect of the present disclosure, there is provided an apparatus comprising at least one processing core, at least one memory including computer program code, the at least one memory and the computer program code being configured to, with the at least one processing core, cause the apparatus at least to perform as a network node in a wireless communication network, and provide an indication to a user equipment of a first type, the indication informing the user equipment whether the user equipment is allowed to camp on cells of the wireless communication network which do not support user equipments of the first type.

According to a third aspect of the present disclosure, there is provided a method comprising performing as a user equipment of a first type, receiving system information from a cell and determining, based on the system information, that the cell does not support user equipments of the first type, and determining, whether to camp on the cell or to not camp on the cell.

According to a fourth aspect of the present disclosure, there is provided a method, comprising performing as a network node in a wireless communication network, and providing an indication to a user equipment of a first type, the indication informing the user equipment whether the user equipment whether camping is allowed on cells of the wireless communication network which do not support user equipments of the first type.

According to a fifth aspect of the present disclosure, there is provided an apparatus comprising means for performing as a user equipment of a first type, receiving system information from a cell and determine, based on the system information, that the cell does not support user equipments of the first type, and determining, whether to camp on the cell or to not camp on the cell.

According to a sixth aspect of the present disclosure, there is provided an apparatus comprising means for performing as a network node in a wireless communication network, and providing an indication to a user equipment of a first type, the indication informing the user equipment whether the user equipment is allowed to camp on cells of the wireless communication network which do not support user equipments of the first type.

According to a seventh aspect of the present disclosure, there is provided a non-transitory computer readable medium having stored thereon a set of computer readable instructions that, when executed by at least one processor, cause an apparatus to at least perform as a user equipment of a first type, receive system information from a cell and determine, based on the system information, that the cell does not support user equipments of the first type, and determine whether to camp on the cell or to not camp on the cell.

According to an eighth aspect of the present disclosure, there is provided a non-transitory computer readable medium having stored thereon a set of computer readable instructions that, when executed by at least one processor, cause an apparatus to at least perform as a network node in a wireless communication network, and provide an indication to a user equipment of a first type, the indication informing the user equipment whether the user equipment is allowed to camp on cells of the wireless communication network which do not support user equipments of the first type.

### BRIEF DESCRIPTION OF THE DRAWINGS

FIG. 1 illustrates an example system in accordance with at least some embodiments of the present invention;

FIG. 2 illustrates an example system in accordance with at least some embodiments of the present invention;

FIG. 3 illustrates an example apparatus capable of supporting at least some embodiments of the present invention;

FIG. 4 illustrates signalling in accordance with at least some embodiments of the present invention, and

FIG. 5 is a flow graph of a method in accordance with at least some embodiments of the present invention.

### EMBODIMENTS

Using processes disclosed herein, a UE of a certain type, such as a reduced-capability UE, may be allowed to camp on a cell which is not configured to support UE devices of the type, in other words, a cell that does not support UE devices of the type. For example, the cell may have older hardware and/or software which does not know of the UE type and its limitations. Using cell capabilities selectively, the UE may obtain at least some service from the cell, enhancing coverage for UEs of this type.

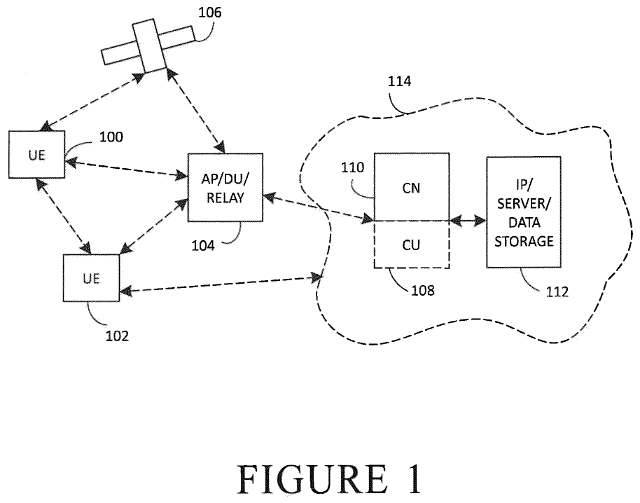

FIG. 1 illustrates an example system in accordance with at least some embodiments of the present invention. In the following, different exemplifying embodiments will be described using, as an example of an access architecture to which the embodiments may be applied, a radio access architecture based on long term evolution advanced (LTE Advanced, LTE-A) or new radio (NR), also known as fifth generation (5G), without restricting the embodiments to such an architecture, however. As a person skilled in the art understands, embodiments may also be applied to other kinds of communications networks having suitable means by adjusting parameters and procedures appropriately.

FIG. 1 depicts examples of simplified system architectures only showing some elements and functional entities, all being logical units, whose implementation may differ from what is shown. The connections shown in FIG. 1 are logical connections; physical connections may be different. It is apparent to a person skilled in the art that the system typically comprises also other functions and structures than those shown in FIG. 1. The embodiments are not, however, restricted to the system given as an example but a person skilled in the art may apply the solution to other communication systems provided with necessary properties.

The example of FIG. 1 shows a part of an exemplifying radio access network. FIG. 1 shows user devices 100 and 102 configured to be in a wireless connection on one or more communication channels in a cell with an access node (such as (e/g) NodeB) 104 controlling the cell. in a 5G radio access network, the access node, also known as base station, may be referred to as a gNB. The physical link from a user device to a (e/g) NodeB is called uplink, UL, or reverse link, and the physical link from the (e/g) NodeB to the user device is called downlink, DL, or forward link. A communications system typically comprises more than one (e/g) NodeB in which case the (e/g) NodeBs may also be configured to communicate with one another over links, wired or wireless, designed for the purpose. The (e/g) NodeB may also be referred to as a base station or an access point, for example, or another type of interfacing device including a relay station such as DU (distributed unit) part of IAB (integrated access and backhaul) node capable of operating in a wireless environment. The DU part may facilitate the gNB functionalities of the IAB node. The (e/g) NodeB includes or is coupled to transceivers. From the transceivers of the (e/g) NodeB, a connection is provided to an antenna unit that establishes bi-directional radio links to user devices 100, 102. The antenna unit may comprise a plurality of antennas or antenna elements. The (e/g) NodeB is further connected to core network 110 (CN or next generation core NGC). Depending on the system, the counterpart on the CN side can be a serving gateway, S-GW, routing and forwarding user data packets, packet data network gateway, P-GW, for providing connectivity of user devices, UEs, to external packet data networks, an access and mobility management function, AMF, or a mobile management entity, MME, for example.

The user device, also called UE, user equipment, user terminal, or terminal device, illustrates one type of an apparatus to which resources on the air interface are allocated and assigned, and thus any feature described herein with a user device may be implemented with a corresponding apparatus, also including a relay node. An example of such scenario is MT (mobile termination) part of IAB node, which provides the backhaul connection for the IAB node.

The user device, or user equipment, typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, surveillance camera and industrial sensor device. It should be appreciated that a user device may also be a nearly exclusive uplink only device.

5G enables using multiple input-multiple output, MIMO, antennas, many more base stations or nodes than the LTE, amounting to a so-called small cell concept, including macro sites operating in co-operation with smaller stations and employing a variety of radio technologies. 5G mobile communications supports a wide range of use cases and related applications including video streaming, augmented reality, different ways of data sharing and various forms of machine type applications, including vehicular safety, different sensors and real-time control. Usage scenarios identified for 5G include enhanced mobile broadband, eMBB, massive machine-type communication mMTC, and Ultra-Reliable and Low Latency communication, URLLC. Yet another identified area is time sensitive communication, TSC. In particular, mMTC, URLLC and TSC are associated with novel Internet of Things, IoT, use cases that are targeted in vertical industries. It is envisaged that eMBB, mMTC, URLLC and TSC use cases may all need to be supported in the same network.

One objective of 5G is to enable connected industries. 5G connectivity can serve as catalyst for industrial transformation and digitalization, which improve flexibility, enhance productivity and efficiency, reduce maintenance cost, and improve operational safety, for example. Devices in such environments include e.g. pressure sensors, humidity sensors, thermometers, motion sensors, accelerometers, actuators, etc. It is desirable to connect these sensors and actuators to 5G radio access and core networks. The massive industrial wireless sensor network, IWSN, is a term used to describe such a networking situation. Likewise, smart city solutions relate to data collection and processing to control and monitor city resources, wherein surveillance cameras are examples of connected devices. Yet further, wearables, such as health monitors, present a use case where 5G connectivity may be of use.

5G has multiple radio interfaces, namely below 6 GHz, cmWave and mmWave, and also being integratable with existing legacy radio access technologies. A frequency range of 600-6000 MHz is defined in 5G as a frequency range 1, FR1, and a frequency range of 26-47 GHz is defined in 5G as frequency range 2, or FR2.

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). Application of cloud RAN architecture enables RAN real time functions being carried out at the RAN side (in a distributed unit, DU 104) and non-real time functions being carried out in a centralized manner (in a centralized unit, CU 108).

5G may also utilize satellite communication to enhance or complement the coverage of 5G service, for example by providing backhauling. Possible use cases include providing service continuity for machine-to-machine, M2M, or IoT devices, for passengers on board of vehicles, or ensuring service availability for critical communications. Satellite communication may utilize geostationary earth orbit, GEO, satellite systems, but also low earth orbit, LEO, satellite systems. Each satellite 106 in the constellation may comprise several satellite-enabled network entities that create on-ground cells. The on-ground cells may be created through an on-ground relay node 104 or by a gNB located on-ground or in the satellite.

As the person skilled will understand, the depicted system is only an example of a part of a radio access system and in practice, the system may comprise a plurality of (e/g) NodeBs, the user device may have an access to a plurality of radio cells and the system may comprise also other apparatuses, such as physical layer relay nodes or other network elements, etc. A cellular radio system may be implemented as a multilayer network including several kinds of cells, such as macrocells, microcells and picocells, for example. Typically, in multilayer networks, one access node provides one kind of a cell or cells, and thus a plurality of (e/g) NodeBs are required to provide such a network structure.

In unlicensed-band NR operation, a bandwidth part, BWP, may comprise plural sub-bands separated from each other by guard bands. The sub-bands may be, but need not be, 20 MHz wide, for example. Operation on the BWP may proceed based on sub-band specific listen-before talk, LBT, operation. In LBT, a node desiring to use a spectrum resource will listen on the resource before using it, and only proceed to transmit on the resource in case the listening indicates the resource appears to be free, that is, not currently in use.

A bandwidth part, BWP, is a contiguous set of physical resource blocks, PRBs, on a given carrier. A carrier bandwidth may be 40 MHz, 80 MHz or 160 MHz, for example. These PRBs are selected from a contiguous subset, for example a proper subset, of the usable common resource blocks for a given numerology on a carrier. A BWP may be characterized by the following features: subcarrier spacing, SCS, sub-band number and sub-band bandwidth. SCS may take values such as 15 kHz, 30 kHz or 60 kHz, for example. A carrier may comprise 1, 2, 3, 4, 5 or 8 sub-bands of 20-MHz bandwidth, for example. A PRB may have 12 subcarriers, for example. Likewise, a normal scheduling unit in time (known as a slot) may be 12 or 14 OFDM symbols long. Furthermore, NR supports mini-slot based operation with the scheduling unit in time smaller than one slot, for example 2, 4 or 7 OFDM symbols. In 5G, the PRB may be 12 subcarriers wide and 14 OFDM symbols long, assuming a normal cyclic prefix. A transmission bandwidth, TX BW, is a part of the spectrum on which a base station actually transmits following the listening phase of LBT of a sub-band specific LBT process. The TX BW may be the entire bandwidth of BWP, or a portion thereof, in dependence of a result of the listening phase.

In general, a UE may be of a reduced-capability type in 5G and accomplish at least some of the goals described above. For example, a sensor, industrial automation node or surveillance camera need not have all the functionality of a regular general-purpose 5G UE, such as a smartphone, for example. In detail, reduced-capability UEs may need far less bandwidth in data transmission, they may perform well without media codecs or support for demanding mobility scenarios, as surveillance cameras, for example, are stationary and have radio paths to base stations which change only as a response to movements in objects reflecting radio signals in the cell. Reduced complexity of the UE provides benefits in that unnecessary hardware parts may be omitted from the UE modules.

Concerning reduced-capability UEs, industrial wireless sensors in 5G have reference use cases and requirements, wherein communication service availability is 99.99% and end-to-end latency less than 100 ms. The reference bit rate in the reference use cases is less than 2 Mbps, with potentially asymmetric UL heavy traffic, for all use cases and the device is stationary. The battery may be expected to last at least few years. For safety related sensors, a more stringent latency requirement 5-10 ms may be applied.

Further concerning reduced-capability UEs, in video surveillance reference use cases an economic video bitrate is 2-4 Mbps, latency <500 ms, and reliability 99%-99.9%. High-end video for farming purposes, for example, would require a bitrate of 7.5-25 Mbps. In wearables, reference bitrate for smart wearable application can be 5-50 Mbps in DL and 2-5 Mbps in UL, and peak bit rate of the device can be higher, up to 150 Mbps for downlink and up to 50 Mbps for uplink. The battery of the device should last multiple days.

A reduced-capability UE may have a reduced capacity, compared to a UE which is not a reduced-capability UE, in one or more of its technical aspects. For example, the reduced-capability UE may have a bandwidth reduction, according to which it is limited to a 20 MHz bandwidth in FR1, and to 100 MHz in FR2. The bandwidth reduction applies to both initial access and communication subsequent to initial access. Further, the reduced-capability UE may have a receiver branch reduction, wherein the reduced-capability UE has one or two receivers, only. A non-reduced, general-purpose UE may have up to four receivers, for example. In detail, in frequency bands where a non-reduced UE is specified as having a minimum of two receivers, a reduced-capability UE may have a single receiver, only, although the reduced-capability UE may have two receivers in those bands. Likewise in frequency bands where a non-reduced UE is specified as having a minimum of four receivers, a reduced-capability UE may have a single receiver, or two receivers. Further, the reduced-capability UE may have a MIMO reduction, wherein the reduced-capability UE may have a single DL MIMO layer in case it has one receiver, and two DL MIMO layers in case it has two receivers. Further, the reduced-capability UE may have a modulation order reduction, for example in that supporting 256-QAM (quadrature amplitude modulation) is optional, rather than mandatory, as for non-reduced capacity UEs. Lastly, the reduced-capability UE may have a duplex reduction, wherein half-duplex FDD, HD-FDD, type A is supported but full duplex FDD, FD-FDD, is not necessarily supported. Reduced capability UEs may, unlike non-reduced UEs, lack support for carrier aggregation and dual connectivity.

The network should not offer, or allow, reduced-capability type UEs access to aspects of the network, such as wider bandwidths, that these UEs do not support. To inform the network of the UE type, reduced-capability UEs may be configured to indicate their reduced-capability type in an early stage of signalling, for example in a random access process. In detail, the msg1 or msg3 message of a random access process may be furnished with an indication that the UE sending it is a reduced-capability UE. The network may configure reduced-capability UE specific random access resources, and the network will know that a UE using these resources, that is, transmitting random access messages using these resources, is a reduced-capability UE. A random access process may comprise the msg1, containing a random access preamble, from the UE to the network, to which the network responds with an msg2, known as a random access response, to which the UE responds with an msg3. The transmission of msg3 may use an uplink grant communicated in msg2.

The base station transmits system information in the cell, for example by broadcasting, the system information, SI, which is comprised in SI blocks. The SI may comprise indications of cell capabilities/configurations of the cell transmitting the SI, for example, the SI may comprise an indication, implicit or explicit, as to whether the cell is configured to support reduced-capability UEs. The indication may specify a number of receivers of the reduced-capability UE that is allowed to camp on the cell, for example, the SI may indicate that reduced-capability UEs with two receivers are allowed, while single-receiver reduced-capability UEs are not. As reduced-capability UEs are foreseen to operate for long periods between charges of battery power, discontinuous reception, DRX, may be of considerable interest for such UEs. A cell may specify, for example in the SI, whether it supports extended DRX for reduced-capability UEs, for example ones in Idle or Inactive states. DRX cycles of up to 10.24 seconds, to up to 10485.76 seconds, may be supported, for example. Radio resource management, RRM, processes for neighbouring cells may be simplified for reduced-capability UEs, in comparison with non-reduced, general-purpose UEs. For radio resource control, RRC, RRC_Idle, Inactive and Connected states, considering the alternatives identified in the SI, RRM simplification may be configurably set on or off for reduced-capability UEs by the network. Such configuration may take place over broadcast or dedicated signalling.

Depending on the embodiment, reduced-capability UEs may have one or more of the reduced aspects mentioned above. For example, a reduced-capability UE may have a combination of the bandwidth reduction and the radio receiver number reduction. As another example, a reduced-capability UE may have a combination of the bandwidth reduction and the maximum modulation order reduction.

In the SI, the cell may include a reduced-capability UE specific intra frequency reselection indication, IFRI. Inclusion of this indication indicates to UEs also that the cell is configured, overall, to support reduced-capability type UEs. Thus, using this or another mechanism, the cell may indicate in SI, whether it is configured to support the reduced-capability type UEs. The absence of the IFRI, or other indication of support, may be seen as an indication the cell is not configured to support reduced-capability type UEs. In some cases a reduced-capability UE may operate on a cell not configured to support reduced-capability UEs in specification compliant manner, however.

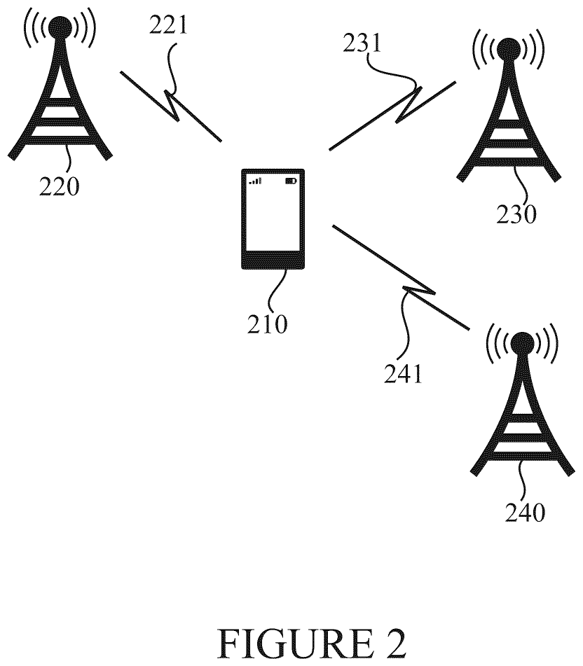

FIG. 2 illustrates an example system in accordance with at least some embodiments of the present invention. Reduced-capability UE 210 is camped on a cell of base station 220. A bidirectional radio interface 221 is used between UE 210 and base station 220. UE 210 searches for a new cell to camp on, for example as a response to moving toward a cell edge of the current cell of base station 220. Base stations 230 and 240 control cells which are potential new cells for UE 210 to camp on, and these cells transmit, for example broadcast, their SI over wireless interfaces 231 and 241, respectively. Each of radio interfaces 221, 231 and 241 may be based on the 5G radio access technology, also known as new radio, NR.

UE 210 can receive the SI on the respective candidate cells, and UE 210 can determine, based on the SI, whether the cells of base station 230, and the cell of base station 240 are configured to support reduced-capability UEs, such as UE 210. In the example of FIG. 2, the cell of base station 240 is configured to support reduced-capability UEs and the cell of base station 230 is not so configured. The system information may comprise cell selection and re-selection criteria, and a bandwidth of initial bandwidth part, BWP for UL and DL. The SI of the cell of base station 230 may lack all reduced-capability UE related information, thus indirectly indicating the lack of support in the cell for the reduced-capability UE type. Alternatively, the SI of the cell of base station 230 may comprise an indicator explicitly indicating that reduced-capability UEs are not supported in the cell.

UE 210 may decide which cell to camp on, based on various criteria which may include, for example, received signal strengths and radio path characteristics to the respective base stations which control the candidate cells. In particular, UE 210 may determine to camp on the cell of base station 230, in other words, the cell not configured to support reduced-capability UEs, such as UE 210. In some embodiments, base station 220 may inform the UE, whether it is allowed to camp on cells which are not configured to support reduced-capability type UEs. UE 210 may determine the frequency range, such as FR1 or FR2, and band where the chosen cell operates. This information may be deduced by the UE from the SI, for example or the UE may know the frequency range and band based on how the UE tunes its receiver. The reduced-capability UE with one or two radio receivers may, in general, be allowed to camp and access a cell not configured to support reduced-capability UEs regardless of whether a reduced-capability UE specific IFRI is present in system information of the cell.

In a first example, a reduced-capability UE with one or two radio receivers may camp and access a cell not configured to support reduced-capability UEs. For example, camping and access can be allowed only on certain bands and/or a certain frequency range, such as only on FR1. Frequency bands allowed for reduced-capability UEs may be specified statically in the UE or signalled to the UE, for example using non-access stratum, NAS, or radio resource control, RRC, signalling or provisioned in a subscriber identity module, SIM, card. In particular, the allowed frequency bands may form a proper subset of an overall cell frequency range of the cell and some frequency bands of the cell may be un-allowed for reduced-capability UEs.

In a second example, a reduced-capability UE with one or two radio receivers is allowed to camp and access a cell not supporting reduced-capability UE in good radio conditions only or in better radio conditions than UE devices not of the reduced-capability type. A radio path criterion, expressed, for example, in terms of reference signal received power, RSRP, and/or reference signal received quality, RSRQ, may be used in determining if the radio conditions are sufficiently good. Cell selection and/or re-selection criteria signalled in the SI of the cell may be adjusted by the reduced-capability UE when operating in that cell. The cell, in this example, needs to be a certain amount better, in terms of a radio metric than for the case of UEs not of the reduced-capability type in cell selection and/or re-selection. A reduced-capability UE may use an offset, such that the cell needs to be better than for the non-reduced capacity UE by the offset for cell selection and/or re-selection as defined in a RSRP, and/or RSRQ, criterion. In one example, such an offset may be configured to the UE by cells supporting use, by reduced-capability UEs, of cells not supporting reduced-capability UEs. The offset may be expressed in decibels (e.g. dB or dBm), for example.

In a third example, a reduced-capability UE with one or two radio receivers is allowed to camp and access a cell not supporting reduced-capability UE only in case the bandwidth of the initial BWP(s), UL and DL, is compliant with the maximum bandwidth criterion for the reduced-capability UE, for example 20 MHz in FR1 and/or 100 MHz in FR2. The first, second and third examples may be combined in all suitable ways in different embodiments of the present invention.

Technical advantages and benefits of the above include an effective coverage extension for the reduced-capability UEs and a more flexible use of network resources.

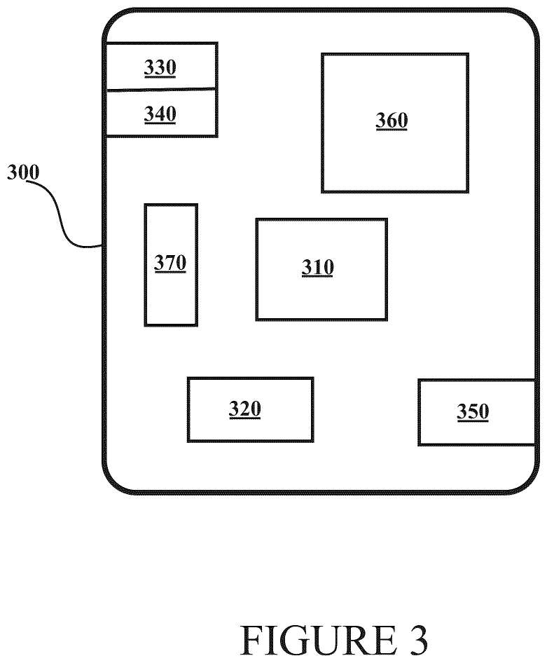

FIG. 3 illustrates an example apparatus capable of supporting at least some embodiments of the present invention. Illustrated is device 300, which may comprise, for example, a mobile communication device such as UE 210, or, in applicable parts, a base station of FIG. 2. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor. Processor 310 may be a control device. A processing core may comprise, for example, a Cortex-A8 processing core manufactured by ARM Holdings or a Zen processing core designed by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300, such as performing, receiving, determining, using and providing. Processor 310 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to configure industrial process parameters.

Device 300 may comprise or be arranged to accept a user identity module 370. User identity module 370 may comprise, for example, a subscriber identity module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

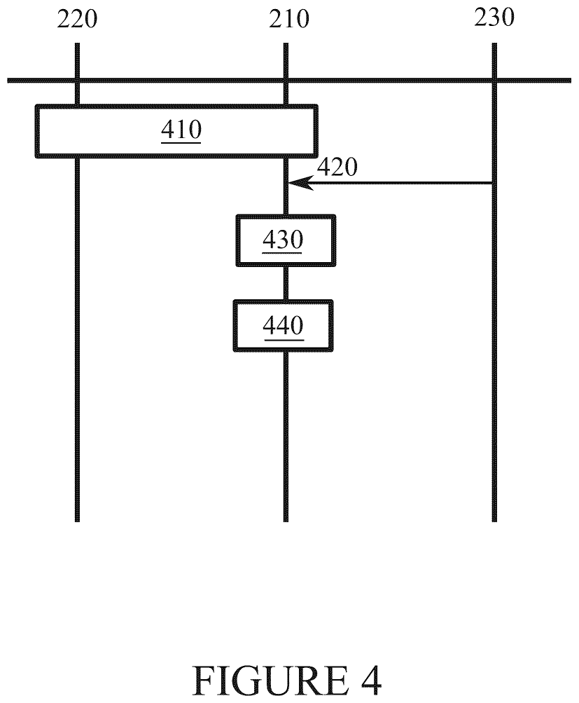

FIG. 4 illustrates signalling in accordance with at least some embodiments of the present invention. On the vertical axes are disposed, on the left, base station 220, in the centre UE 210 and on the right, base station 230, each of FIG. 2. Time advances from the top toward the bottom.

In phase 410, UE 210 is camped on a cell of base station 220. Base station 220 may inform UE 210 of whether the UE, which is of the reduced-capability type, is allowed to camp on cells of the communication network which are not configured to support reduced-capability type UEs.

In phase 420, UE 210 receives a system information, SI, broadcast from the cell of base station 230, the SI indicating explicitly or implicitly that the cell is not configured to support reduced-capability UEs. For example, the SI may have no indications whatsoever concerning reduced-capability UEs. It is possible that the cell of base station 230 is a so-called legacy cell which is ignorant of the reduced-capability UE type.

In phase 430, UE 210 considers whether to take actions to camp on the cell of base station 230, regardless of the lack of support for the type of UE which UE 210 represents. In dependence of the determination of phase 430, the UE in phase 440 takes actions aimed to cause it to camp on the cell of base station 230, or no. If the UE decides in phase 430 to not begin camping on the cell of base station 230, then UE 210 may continue searching for new cells in phase 440. In general, one base station may control plural cells, wherefore the various cells discussed are not necessarily those of different base stations.

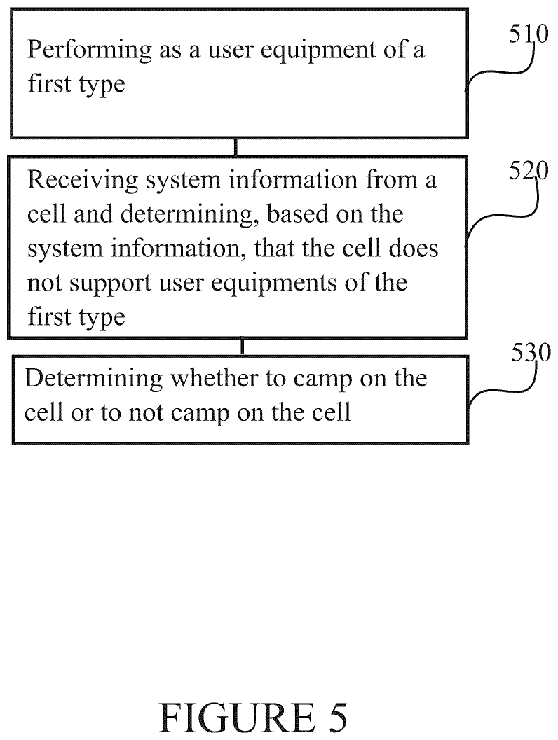

FIG. 5 is a flow graph of a method in accordance with at least some embodiments of the present invention. The phases of the illustrated method may be performed in UE 210, or in a control device configured to control the functioning thereof, when installed therein.

Phase 510 comprises performing as a user equipment of a first type. The first type may be the reduced-capability type, for example. Phase 520 comprises receiving system information from a cell and determining, based on the system, information, that the cell does not support user equipments of the first type. Finally, phase 530 comprises determining, whether to camp on the cell or to not camp on the cell. The determining of phase 530 may be based at least in part on the system information. In case the determination of phase 530 is to camp on the cell, the method may further comprise camping on the cell. The determination of phase 530 may comprise determining to camp on the cell regardless of the fact the cell does not support user equipments of the first type.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in wireless communication.

1.-34. (canceled)

35. An apparatus comprising at least one processing core, at least one memory including computer program code, the at least one memory and the computer program code being configured to, with the at least one processing core, cause the apparatus at least to:
perform as a user equipment of a first type;
receive system information from a cell and determine, based on the system information, that the cell does not support user equipment of the first type, and
determine, whether to camp on the cell or to not camp on the cell.

36. The apparatus according to claim 35, wherein the first type comprises a fifth generation, 5G, reduced capability user equipment, wherein the reduced capability user equipment has reduced capability with respect to user equipment not of the first type in regard to one or more of the following: a maximum bandwidth, a number of radio receivers, a number of downlink multiple input multiple output layers, a maximum supported modulation order and duplex operation capability.

37. The apparatus according to claim 35, wherein the user equipment complies with a bandwidth criterion which comprises either a maximum bandwidth of 20 MHz within a frequency range of 600-6000 MHz, or a maximum bandwidth of 100 MHz within a frequency range of 26-47 GHz.

38. The apparatus according to claim 35, wherein the apparatus is configured to determine to camp on the cell using only a proper subset of a cell frequency range of the cell.

39. The apparatus according to claim 35, wherein the apparatus is configured to determine to camp on the cell only in case a radio path criterion, applied to a radio path between the apparatus and a base station controlling the cell, is satisfied, the radio path criterion being stricter than a second radio path criterion applying to user equipment not of the first type.

40. The apparatus according to claim 39, wherein at least one of:
the radio path criterion is expressed in terms of reference signal received power and/or reference signal received quality; and
the apparatus is configured to use an adjusted version of at least one cell selection and/or cell re-selection criterion of the cell.

41. The apparatus according to claim 37, wherein the apparatus is configured to perform the determining to camp on the cell only in case an initial bandwidth part, used in attaching to the cell, complies with the bandwidth criterion.

42. The apparatus according to claim 35, wherein the apparatus is configured to perform the determining whether to camp on the cell without taking into regard presence or absence, in the system information, of an inter-frequency reselection indication specific to user equipment of the first type.

43. The apparatus according to claim 35, wherein the apparatus comprises one of:
one and only one radio receiver; or
two and only two radio receivers.

44. The apparatus according to claim 35, wherein at least one of:
the apparatus is configured to search for other cells responsive to the determination to not camp on the cell; and
the apparatus is configured to perform the determination whether to camp on the cell based at least in part on a frequency range and/or frequency band on which the cell operates.

45. A method comprising:
performing as a user equipment of a first type;
receiving system information from a cell and determining, based on the system information, that the cell does not support user equipment of the first type, and
determining, whether to camp on the cell or to not camp on the cell.

46. The method according to claim 45, wherein the first type comprises a fifth generation, 5G, reduced capability user equipment, wherein the reduced capability user equipment has reduced capability with respect to user equipment not of the first type in regard to one or more of the following: a maximum bandwidth, a number of radio receivers, a number of downlink multiple input multiple output layers, a maximum supported modulation order and duplex operation capability.

47. The method according to claim 45, wherein at least one of:
the user equipment of the first type complies with a bandwidth criterion which comprises either a maximum bandwidth of 20 MHz within a frequency range of 600-6000 MHz, or a maximum bandwidth of 100 MHz within a frequency range of 26-47 GHz; and
the method comprises performing the determining to camp on the cell only in case a radio path criterion, applied to a radio path between the apparatus and a base station controlling the cell, is satisfied, the radio path criterion being stricter than a second radio path criterion applying to user equipment not of the first type.

48. The method according to claim 45, further comprising performing the determining to camp on the cell and determining to use only a proper subset of a cell frequency range of the cell.

49. The method according to claim 47, wherein at least one of:
the radio path criterion is expressed in terms of reference signal received power and/or reference signal received quality; and
using an adjusted version of at least one cell selection and/or cell re-selection criterion of the cell.

50. The method according to claim 47, wherein the method further comprises performing the determining to camp on the cell only in case an initial bandwidth part, used in attaching to the cell, complies with the bandwidth criterion.

51. The method according to claim 45, wherein the method further comprises performing the determining whether to camp on the cell without taking into regard presence or absence, in the system information, of an inter-frequency reselection indication specific to user equipment of the first type.

52. The method according to claim 45, wherein the user equipment comprises one of:
one and only one radio receiver; or
two and only two radio receivers.

53. The method according to claim 45, wherein the method further comprises at least one of:
searching for other cells responsive to the determination to not camp on the cell; and
performing the determination whether to camp on the cell based at least in part on a frequency range and frequency band on which the cell operates.

54. An apparatus comprising means for:
performing as a user equipment of a first type;
receiving system information from a cell and determine, based on the system information, that the cell does not support user equipment of the first type, and
determining, whether to camp on the cell or to not camp on the cell.
